(19) United States
(12) Patent Application Publication
(10) Pub. No.: US 2012/0151094 A1
(43) Pub. Date: Jun. 14, 2012

(54) Method and Apparatus for Internet Browsing

(75) Inventor: David Hinton Cooke, Melbourne (AU)

(73) Assignee: NETWORK HOLDINGS AUSTRALIA PTY LTD, Melbourne, Victoria (AU)

(21) Appl. No.: 13/390,941

(22) PCT Filed: Aug. 20, 2010
(86) PCT No.: PCT/AU2010/001067

§ 371 Date: Feb. 17, 2012

(30) Foreign Application Priority Data
Aug. 20, 2009 (AU) 2009903944

(51) Int. Cl. G06F 15/16

(52) U.S. Cl. 709/250

(57) ABSTRACT

The present application relates to a method and apparatus for digital data processing systems suitable for providing Internet browsing within a computer network. In particular, the present application provides a method of operating a data processing system. The method may include the step of operatively divesting the browsing of web sites from the central processing of applications. In another aspect, the present application provides a data processing system that may include: central processing means adapted to operate in accordance with a predetermined instruction set and an Internet browser function; the central processing means, in conjunction with the Internet browser function, being adapted to perform web browsing wherein the Internet browser function is operatively divested from the central processing means.

### RELATED APPLICATIONS

The present application claims priority to Australian Provisional Patent Application No. 2009903944 in the name of Network Holdings Australia Pty Ltd, which was filed on 20 Aug. 2009, entitled “Method and System for Internet Browsing” and the specification thereof is incorporated herein by reference in its entirety and for all purposes.

### FIELD OF INVENTION

The present Invention relates generally to the field of information technology and telecommunications. In particular, the present invention relates to a method and apparatus for digital data processing systems suitable for use in providing applications such as Internet browsing within a computer network.

It will be convenient to hereinafter describe the invention in relation to use of a personal computing (PC) architecture supplemented with dedicated hardware components for providing Internet browsing functions, however it should be appreciated that the present invention is not limited to that use, only.

### BACKGROUND ART

It is to be appreciated that any discussion, of documents; devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

An Internet browser or web browser usually takes the form of a software application having the ability for retrieving, presenting, and traversing information resources on the World Wide Web but may generally be described as a program providing the means for viewing the contents of nodes and of navigating from one node to another. Netscape Navigator™ from Netscape Communications Corporation and Internet Explorer™ from Microsoft Corporation are examples of browsers for the World Wide Web. An information resource that is retrievable via a computer network may be identified by a Uniform Resource Identifier (URI) or, more specifically, a Uniform Resource Locator (URL) and may be a web page, image, video, or other form of content. Hyperlinks located within resources enable users to navigate via the browser's functions to related resources.

Although browsers are primarily intended for accessing information in the World Wide Web, they may also be utilised for accessing and displaying information provided by web servers in private networks or content in file systems.

According to the following Wikipedia entry found at the following URI, “http://en.wikipedia.org/wiki/Internet_Browser”, the purpose of a browser is to display resources to the user. This process begins when the user inputs a Uniform Resource Identifier (URI), for example http://en.wikipedia.org/, into the browser. The prefix of the URI determines how the URI will be interpreted. The most commonly used form of URI starts with “http:” and identifies content to be retrieved over Hypertext Transfer Protocol (HTTP). Many browsers also support a variety of other prefixes, such as “https:” for HTTPS, “ftp:” for the File Transfer Protocol, and “file:” for local files. Prefixes that a browser cannot directly handle may be handed off to another application entirely. For example, “mailto:” URI's are usually passed into the user's default e-mail application, and “news:” URI's are passed to the user's default newsgroup reader application. In the case of “http:”, “https:”, “file:”, and others, once the content has been retrieved the browser may set about displaying it to the user. HTML is handed off to the browser's layout engine to be transformed from ‘markup’ (artificial computer language that Is used to annotate a document's content to give instructions regarding the structure of text or how it is to be displayed) to an interactive document. Aside from HTML, web browsers can generally display any kind of content that can be part of a web page. Most browsers can display images, audio, video, and XML files, and often have plug-ins to support Flash files and Java™ applets to name some examples. Upon encountering a file of an unsupported type or a file that is set up to be downloaded rather than displayed, the browser may prompt the user to save the file to disk.

As part of the features of browsers, most major web browsers allow the user to open multiple information resources at the same time, either in different browser windows or in different tabs of the same window. Many known browsers also include pop-up blockers to prevent unwanted windows from “popping up” without the user's consent. Most web browsers can display a list of web pages that the user has bookmarked so that the user can quickly return to them. Bookmarks are also called “Favorites” in the Internet Explorer™ browser application. In addition, all major web browsers may have some form of built-in web feed aggregator. In the Mozilla Firefox™ browser application, web feeds are formatted as “Live bookmarks” and behave like a folder of bookmarks corresponding to recent entries in the feed. In another proprietary browser known as Opera™, a more traditional feed reader is available which stores and displays the contents of the feed.

Furthermore, most browsers can be extended via plug-ins, downloadable components that provide additional features. Early web browsers supported only a very simple version of HTML. The rapid development of proprietary web browsers has led to the development of non-standard dialects of HTML, leading to problems with interoperability. Modem web browsers may support a combination of standards-based and de facto HTML and XHTML, which ideally should be rendered in the same way by all browsers.

Successive generations of browser development within general computing platforms have created functionally rich but more complex and sizeable implementations introducing performance issues, particularly in older systems. As relatively more time is spent browsing than on computationally intensive applications, the energy consumption of more modern system architectures featuring multiple processor cores and higher clock rates are increasingly out of balance with actual requirements. It is considered that Internet browsers have also become more prone to security attacks through alterations to basic browser code and behaviour within the known implementations.

Published U.S. patent application Ser. No. 11/937,613 to Woodring et al. (Publn No 200910125708) discloses an ‘Internet appliance’ comprising apparatus dedicated to accessing predetermined information in a computer data network. The Woodring appliance addresses the problem of a large number of people using the Internet who find general purpose computers hard to use and/or who are put off by problems presented by general purpose computers. The apparatus of Woodring et al itself comprises a display, firmware associated with the display wherein the firmware includes an operating system and a web browser, which are configured to automatically obtain configuration information from one or more remote data servers upon boot of the operating system, and based on that configuration information, connect to one or more internet servers using the web browser and automatically display content therefrom. Essentially, the device of Woodring et al is limited to use as an internet-connected appliance for kiosk use which automatically gets its content and configuration from a centralised server where a simplified internet based web application allows the content and layout depicted on the appliance to be customised to a user's specific preferences. Whereas the device of Woodring et al is intended to simplify browser usage by limiting local processing capability, it uses a general purpose processor running both the operating system and browser and requires the use of a geographically separated, dedicated data server for start-up configuration management.

Published U.S. patent application Ser. No. 10/904,672 to Taggart (Publn No 2006/0123096) discloses a method and apparatus for remote site access of a multi-core processor computing system for creating a system for computer capability access points from remote locations to a single computer terminal equipped with at least one multi-processor central processing unit. Taggart shows a computing system that utilizes a single computer equipped with a multi-core processor (central processing unit), but not limited to one. In one embodiment, the computing system is in wireless communication with a remote work site that permits multiple parallel access to the multi-processor computer system without the need for a host computer and central processing unit at the remote locations. To illustrate the system of Taggart in a typical example, FIG. 2 of Taggart depicts the multi-core processor 200 as one piece of silicon that contains two separate cores 204 capable of performing parallel independent processor computing instructions. Another example, not depicted in the embodiments, includes two pieces of separate silicon enclosed on the same package with the purpose of creating a multi-core processor computing system. Another example, not depicted in the embodiments, includes one piece of silicon that contains four cores which is enclosed in, a package. In each example, the individual cores making up the multi-core processor 200 are designed and manufactured with the ability to operate independent of the other cores when instructed and accessed by more than one user, The Independent operation of each core within the multi-core processor is managed by the software and hardware of the computing system. In other words, Taggart discloses a system that use multiple cores or processors of the same design all controlled by the operating system. Whilst the system of Taggart may replicate computer processing functions it does not address any need for improving the operation of a specific function, namely, browsing in relation to the central operating system.

Published U.S. patent application Ser. No. 11/736,936 to Kriegel et al (Publn No 2008/0263339) discloses a system for context switching between a first thread and a second thread in a multithreading computer system. According to Kriegel et al a problem with multithreading systems occurs during execution of a first thread, where the first thread may use a first virtual address to load information from a non-volatile memory such as a hard drive into a first real address within the processor cache. The processor may then begin executing a second thread. The second thread may use a second virtual address which maps to different information from the hard drive. In some cases, the second virtual address may also map to the same real address (the first real address) used by the first thread to store information in the processor cache. Thus, when the second thread begins execution, the processor cache may appear to contain information corresponding to the second virtual address when, in fact, the information in the cache, previously fetched for the first thread, is incorrect and outdated (e.g., stale). Because the processor cache may contain incorrect information with respect to the second virtual address requested by the second thread, execution of the'second thread using the incorrect information may result in an error.

The solution offered by Kriegel et al provides a means for context switching between a first thread and a second thread and includes detecting an exception generated in response to receiving a packet of information directed to one of a first and second thread and, invoking an exception handler in response to detecting the exception, where the exception handler is configured to remove access to at least a portion of a processor cache that contains cached information for the first thread using a first address translation, thereby preventing the second thread using a second address translation from accessing the cached information in the processor cache and, branching to at least one of the first and second thread. Kriegal et al discloses the use of multiple processor cores, however, like Taggart noted above these multiple cores are all controlled by the operating system and whilst the system of may replicate computer processing functions it does not address any need for improving the operation of a specific function, namely, browsing in relation to the central operating system as discussed above.

Published U.S. patent application Ser. No. 11/772,634 to Bayless et al (Publn No 2008/0010296) discloses a system and method for configuring a parallel-processing database system for database management and in particular for parallel processing of database queries in a parallel processing system. Bayless is particularly directed to limitations of parallel-processing database systems that often implement shared storage resources, such as memory or disk storage, which result in bottlenecks when processors attempt to access the shared storage resources simultaneously. According to Bayless et al to limit the effects of shared storage, some current parallel-processing systems distribute the data of the database to multiple storage devices, which then may be associated with one or more processing nodes of the database system. These implementations, however, often have an inefficient or ineffective mechanism for failure protection when one or more of the storage devices fail. When a failure occurs, the storage device would have to be reinitialized and then repopulated with data, delaying the completion of the database operation. Additionally, the data may be inefficiently distributed among the storage devices, resulting in data spillover or a lack of proper load-balancing among the processing nodes. To address this Bayless et al provides a method and system for configuring a system for processing queries comprising: manipulating at least one processing node of a plurality of processing nodes to operate as a master node of a global-results processing matrix; manipulating each of the remaining processing nodes of the plurality of processing nodes to operate as a slave node of the global-results processing matrix; receiving at least one query; processing the at least one query by the global-results processing matrix; and outputting at least one query result based on the processed at least one query. Each of the processing nodes described in Bayless et al may include a processor which may functionally correspond to any conventional processor as noted in the above discussion of Internet browser functions. However, the processing nodes of Bayless et al are not necessarily configured for browser functions. Nonetheless, if they were, they suffer similar drawbacks to the processors discussed above, for example, as relatively more time is spent browsing than on computationally intensive applications for a processor that includes dedicated browser functions along with it own processing capability, the energy consumption of these processing nodes, which could include more modern system architectures featuring multiple processor cores and higher clock rates are increasingly out of balance with actual requirements. Also, as above, it is considered that Internet browsers included in such processing nodes will have also become more prone to security attacks through alterations to basic browser code and behaviour within the known implementations.

### SUMMARY OF INVENTION

It is an object of the embodiments described herein to overcome or alleviate at least one of the above noted drawbacks of related art systems or to at least provide a useful alternative to related art systems.

In a first aspect of embodiments described herein there is provided a method of operating a data processing system, the method comprising the step of operatively divesting the functions of browsing of web sites from the central processing of applications.

In another aspect of embodiments described herein there is provided a data processing system comprising:

central processing means adapted to operate in accordance with a predetermined instruction set, and;

an Internet browser function;

said central processing means, in conjunction with said Internet browser function, being adapted to perform web browsing wherein the Internet browser function is operatively divested from the central processing means.

In the context of the present description and for the purposes of establishing the scope of the appended claims it is to be understood that the terms “divest”, “divested”, “divesting” and other forms of that word in its use herein in respect of browser functionality is reference to browser functions that are controlled, called and operated independently of the host operating system of a digital processing system, that may in some embodiments be in the form of a central processor means or central processing unit (CPU). By way of example, the use of a hardware based ASIC or its equivalent for implementing a browser in which the hardware based ASIC or its equivalent are physically separate and independently controlled with respect to the host operating system of a digital processing system is an effective, practical and advantageous means of operatively divesting an Internet browser function from a central processing means.

Preferably, the data processing system in accordance with preferred embodiments comprises computer logic hardware dedicated to operating in accordance with browser application software code for implementing the Internet browser function wherein the computer logic hardware resides within an integrated circuit chip housing the central processor means.

Alternatively, the computer logic hardware dedicated to operating in accordance with browser application software code for implementing the Internet browser function may reside within a first integrated circuit chip physically separated from a second integrated circuit chip housing the central processor means. In a preferred embodiment the first and second integrated circuit chips are physically located on one and the same CPU printed circuit board. Alternatively, the first and second integrated circuit chips may be physically located on separate IC printed circuit boards.

In another alternative embodiment, the computer logic hardware may reside, at least in part, on a printed circuit board separate to a printed circuit board housing the central processor means.

In yet a further alternate embodiment the computer logic hardware dedicated to operating in accordance with browser application software code for implementing the Internet browser function may reside, at least in part, within a peripheral device of the data processing system.

In preferred forms of the present invention a software mediation layer is provided and is adapted to communicate messages between an application layer of the data processing system and the operatively,divested browser function. In a preferred embodiment, the software mediation layer is adapted for by-passing a pre-existing browser application resident in the application layer of the data processing system. Preferably, the software mediation layer resides within an application layer of the data processing system. The messages communicated between the application layer and the operatively divested browser function may comprise one or a combination of browser tasks and instructions.

In yet another preferred aspect of embodiments disclosed herein there is provided a method of operating a data processing system having a central processor means, the method comprising the step of:

mediating the processing of browser functions between an operating system and hardware logic operatively separated from the operating system.

In yet a further aspect of embodiments described herein there is provided a computer program product comprising:

a computer usable medium having computer readable program code and computer readable system code embodied on said medium for operatively isolating the browsing of web sites from the central processing of applications within a data processing system, said computer program product comprising:

computer readable code within said computer usable medium for performing the method steps of operatively divesting the functions of browsing of web sites from the central processing of applications.

Other aspects and preferred forms are disclosed in the specification and/or defined in the appended claims, forming a part of the description of the invention.

In essence, embodiments of the present invention stem from the realization that past implementations of Internet browsers have been based on the use of a general computing platform, which is in control of and/or operates the relevant user device, typically a personal computer or mobile phone architecture, to provide the browser functionality and, in contrast, divesting the function(s), in part or in total, of an Internet browser from the central processing unit of a computing or data processing device to dedicated hardware may deliver significant performance, energy and security improvements. Optional implementations of embodiments of the present invention comprise the following:
A browser implementation improving speed, security, reliability and energy efficiency through dedicated hardware to run the browser separate from a host PC CPU;
The browser code may run on dedicated logic hardware within the CPU chip providing a high level of integration with the host system, and therefore advantage in terms of increased speed and cost,
The browser code may run on dedicated logic hardware within separate chips on the CPU board allowing downstream manufacturers beyond the CPU manufacturers to realize the benefits of the present invention within their new system designs
The browser code may run on dedicated logic hardware residing on a separate board within the computer allowing, existing system owners to realize the benefits of the present invention without replacement of their current system.
The browser code may run on dedicated logic hardware within a peripheral of the computer allowing existing system owners to realize the benefits of the present invention without replacement of their current system, particularly where such systems do not have internal expansion capability
A software mediation layer is provided to pass off browser tasks to and from the dedicated internet processor and allowing powering down of non-active peripherals, and control of the dedicated browser hardware.

Embodiments of the present invention avoid imposing limitations, such as that found in Woodring et al noted above where there is a requirement to use a geographically separated and dedicated data server for start-up configuration management. Moreover, embodiments of the present invention may provide full access to all host functions including local data storage and paging, browser acceleration through browser code executing in dedicated application specific hardware, low energy consumption through the use of standby states for non-active peripherals, and security improvements through the avoidance of browser code modification.

Advantageous and distinguishing features of embodiments of the present invention include the use of a dedicated hardware implementation of the browser code and its ability to function within existing host architectures rather than define a new display/data server architecture, as required for example by Woodring et al.

As such, further practical advantages of embodiments of the present invention comprise:
1. No impact on user operation
2. Faster browsing experience through dedicated hardware acceleration of browser code
3. Reduction in energy usage of systems used predominantly for browsing
4. Increased security since the hardware based logic cannot be modified by software

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 is a general schematic block diagram showing conceptually at least four alternate embodiments of the present invention indicated as integration points in a PC architecture by way of example;

FIG. 2 shows a protocol diagram of a small computer architecture, illustrating a software mediation layer in accordance with a preferred embodiment of the present invention adapted to pass off browser application calls to a dedicated internet processor for controlling the function(s) of Internet browsing;

FIG. 3 is a system block diagram of a computing system comprising an embedded hardware browser in accordance with a first preferred implementation of the present invention;

FIG. 4 is a flow chart illustrating the operation of the system of FIG. 3;

FIG. 5 is a system block diagram of a computing system comprising browser code running on dedicated logic hardware within separate chips on the CPU board of the system in accordance with a second preferred implementation of the present invention;

FIG. 6 is a flow chart illustrating the operation of the system of FIG. 5 wherein the dedicated logic hardware is located in a co-processor installed on a motherboard;

FIG. 7 is a flow chart illustrating the operation of a computing system comprising browser code running on dedicated logic hardware within a card connected to the CPU of the system via a system bus;

FIG. 8 is a flow chart illustrating the operation of a computing system comprising browser code running on dedicated logic hardware located within a peripheral device connected to the CPU of the system via a communication port.

### DETAILED DESCRIPTION

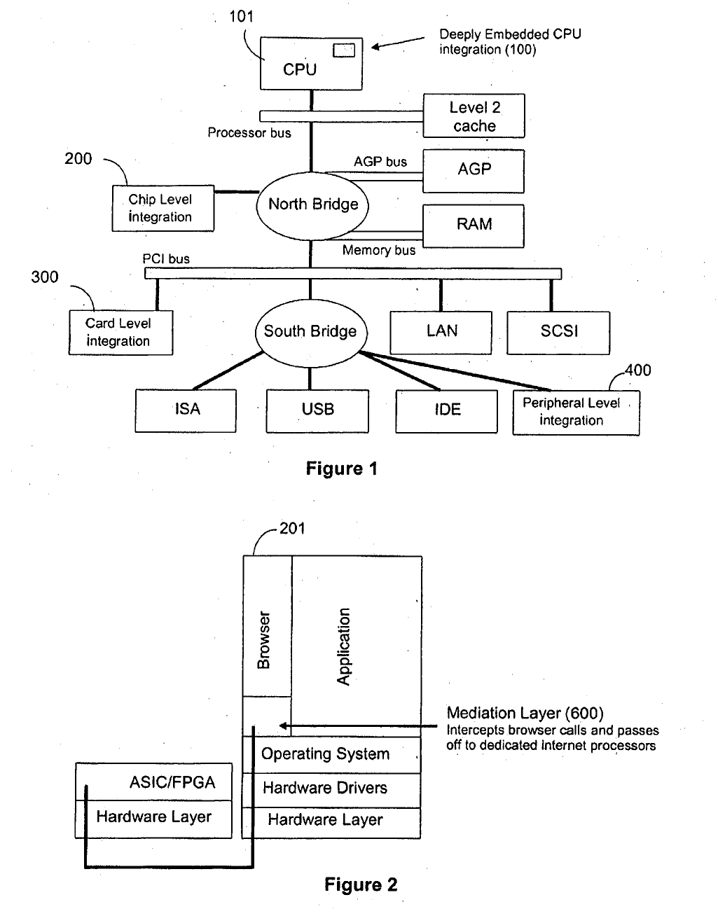

In the field of Internet browsing, a preferred embodiment of the present invention has been specifically devised to improve efficiency of code execution and reduce the security risks while providing major reductions in energy consumption for users whose main activity is browsing. Embodiments of the present invention provide for the integration of a browser as an outsourced hardware based processor separate from the main processing unit of a generic PC. This contrasts with the related art in which there are instances of using solid state hard drives but these are still general purpose computers running multiple tasks of which one is the browser. With reference to FIGS. 1 and 2, a browser in accordance with a preferred embodiment of this invention comprises, in alternate forms 100, 200, 300, 400 as shown in FIG. 1, a hardware based implementation of the browser software with an optional software mediation layer 600, as shown generally in FIG. 2, to allow the host PC or central processing unit 101 in a computing system to delegate or be delegated of browsing to a dedicated hardware sub-system.

In accordance with preferred forms, the browser operation provides for two alternative modes of operation:

Mode A identifies a more granular approach where individual modules of browser code or add-ins are intercepted by the software mediation layer 600 and passed off to hardware based code 100, 200, 300, or 400. As an example and with reference to FIGS. 1 and 2, a browser 201 running within the core and control of a main processor or CPU 101 may pass off execution of java code alone to the hardware based code (100, 200, 300, or 400) resulting in the advantages and benefits noted above accruing to that proportion of browser activity associated with Java code execution. Whilst running in Mode A operation, a computing system may pass off browser functions in the form of an arbitrary number of modules, such as flash or other normally locally processed browser code from the central processor 101.

Mode B identifies a complete divesting of browser functions by delegation of browser and add-in code execution to hardware based code. This is achieved by substitution of the browser executable file 201 destined for processing on the personal computing machine's general purpose processor 101 (as an example browser.exe) with a new file (the mediation layer 600) which presents the standard, expected interfaces to the existing host system, but redirects variables and data to the hardware based code residing within the range of hardware implementation alternatives 100, 200, 300 or 400 identified above.

For clarity the sequence of events and data paths is hereby enumerated:
1. A user of the host machine follows their normal procedure to invoke their browser 201, typically executing “browser.exe”.
2. Taking Mode B, browser.exe actually executes a “subsitutedbrowser.exe” file which has the function of handling inter-process communications with the host machine environment (screen, keyboard, drives, network etc).
3. Subsitutedbrowser.exe may also handle calls to the hardware based code over the existing host machine architecture in accordance with the alternative implementations of preferred embodiments ranging from highly integrated approach 100 of browser code running on dedicated logic hardware within the CPU chip, the motherboard approach 200 of browser code running on dedicated logic hardware within separate chips on the CPU board, the expansion card approach 300 of browser code running on dedicated logic hardware residing on a separate board within the personal computing system, or the external hardware approach 400 of browser code running on dedicated logic hardware within a peripheral device to the computer.
4. The hardware based code (100, 200, 300, or 400) executes the basic browser functions 201, add-in modules and local web page processing within its hardware. At this point browser execution is independent of main memory and other processes running on the main general purpose processor. Accordingly, the browser execution therefore benefits from dedicated execution space provided by the hardware based encoding and consequent speed of execution. As the duty cycle of browsing activities on typical general purpose machines increases, such as experienced with cloud based applications, less resources of the local machine are required (such as main processor speed, high clock speeds, high energy use).
5. The software mediation layer 600 can also interface to the host system's power saving controls to request reduction in energy consumption of non-required peripherals such as hard disks, main processor clock speed and the like.
6. The hardware based module (100, 200, 300, or 400) uses the existing capabilities of the host machine to interface to the user and supporting devices such as printers and storage.

Usage in accordance with Mode A is similar but provides efficiency only for those modules of browser code passed off from the general purpose processor 101. Dependent on the duty cycle and activity of the user, significant speed, and energy efficiencies may accrue.

The execution of browser code is fast, secure and reliable, is independent (In part or in whole) of other software processes running on the host PC or host computing system generally, and the software mediation layer 600 can be configured to reduce power to peripherals not required for online browsing ie power to disks, usb, CD, CPU, Floating Point Processor and the like can all be reduced using existing functionality within the host/host PC.

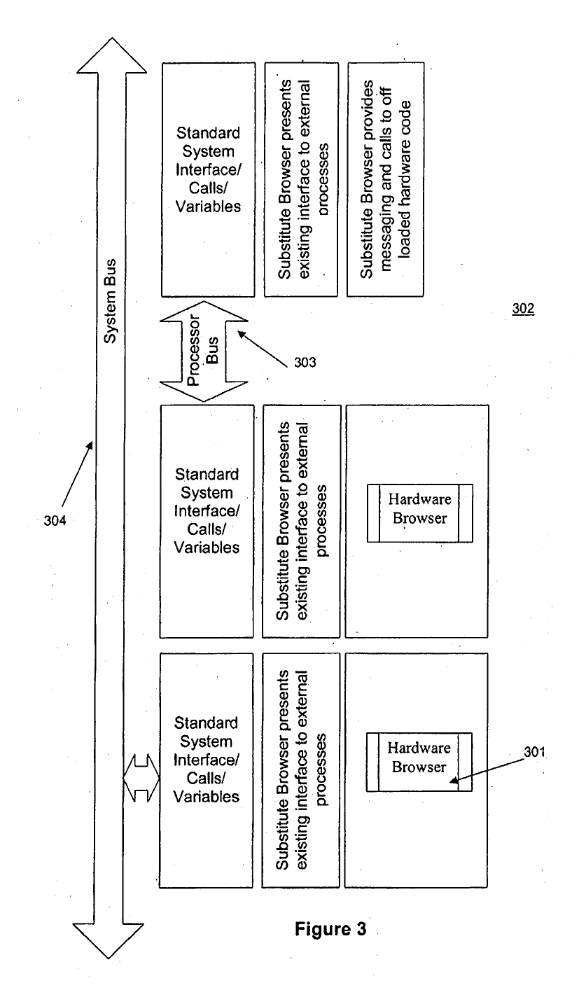

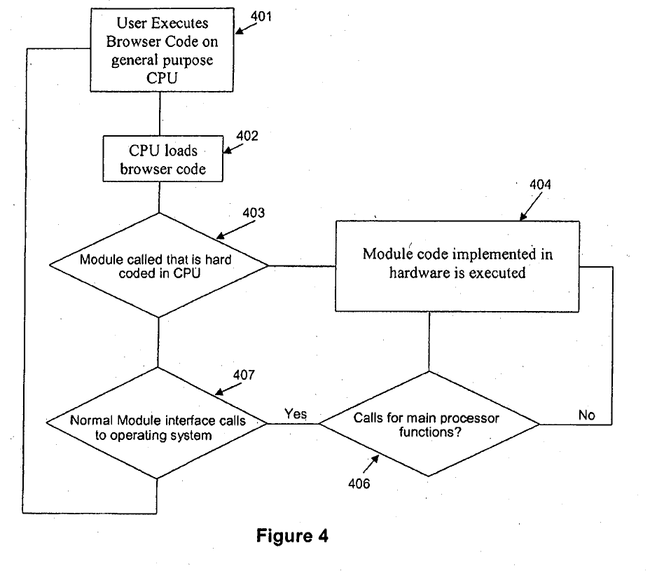

The following description illustrates the four implementations of preferred embodiments of the present invention:
1. Deeply embedded. Here the browser hardware realisation is placed on the CPU chip to achieve the tightest integration with lowest cost. With further reference to FIGS. 1 and 2 and particular reference to FIGS. 3 and 4, the description of the circuit and function for the deeply embedded implementation is as follows:

The general purpose CPU is varied to provide additional logic on the silicon to form a hardware coded browser 301. This code is implemented by placing the browser ASIC realisation within the CPU chip itself, indicated generally as 302 in FIG. 3, such that the browser hardware implementation 301 directly accesses the CPU internal bus 303 rather than the system bus 304 traditionally used to connect other components of the general purpose processor such as memory and I/O.

With reference to FIG. 4, when a browser process is started in accordance with existing computer system designs, step 401, a set of instructions for the process is executed and managed by the CPU along with other processes running concurrently as would be understood by the person skilled in the art. The CPU operating system provides CPU cycles to each process. The browser process for the deeply embedded implementation according to a preferred embodiment of the present invention is initiated in a similar manner at step 402, however, instead of executing solely in the core of the general purpose CPU, the code of the browser is modified to offload either part (Mode A) or all of the browser processing (Mode B) to hard coded logic embedded within the processor chip, step 403. This logic may be changed and upgraded via processes similar to current practice in the art to upgrade system BIOS, as would be appreciated by the person skilled in the art.

A browser code module is called and is executed in the previously defined hardware logic, at step 404, and continues to be so processed until output is required to the main processor, at step 406. Where such output is required the hardware coded logic provides that output to the mediation layer, at step 407, which presents it via the existing interfaces to the operating system. In effect the mediation layer looks like a standard browser to the operating system allowing the operating system to be unchanged, at the same time the mediation layer passes off processing to hardware logic better suited to its execution.

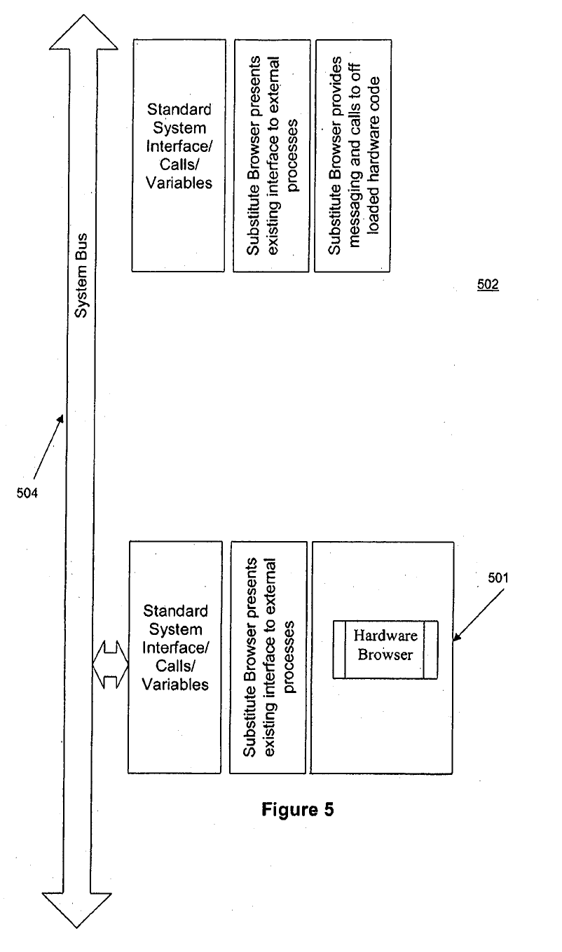

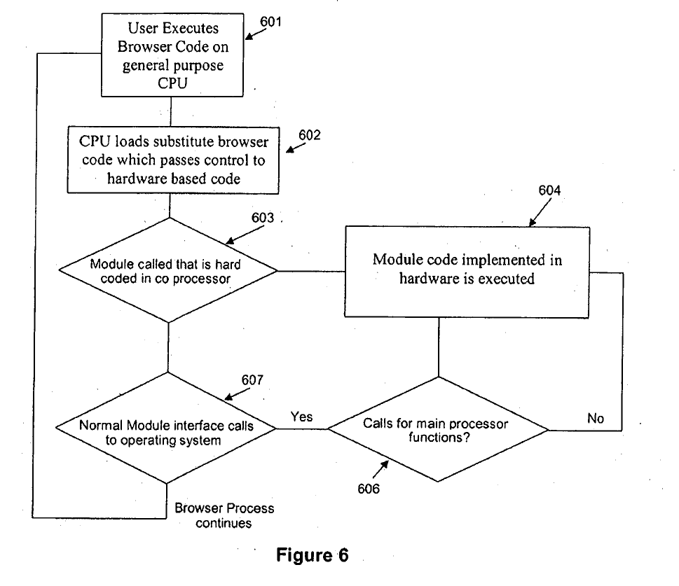

In the deeply embedded implementation, security is improved since the browser code cannot be modified by any process running within the general purpose CPU. Further, speed is improved since the processing time of the browser code in hardware is much faster than the additional processing time to handle calls into and out of the hardware section of the embedded browser logic. In all other respects, in this implementation, the processing load, latency and system management should appear no different from the browser code running on the general purpose CPU or host system.
2. Chip level integration. Here the browser hardware realisation is placed on the same board as the CPU providing good integration cost, and leveraging control of peripherals to achieve energy reduction. With further reference to FIGS. 1 and 2 and particular reference to FIGS. 5 and 6, the description of the circuit and function for the chip level implementation is as follows:

The motherboard containing the general purpose CPU is varied to provide additional logic on stand-alone chips to form the hardware coded browser 501. This code is implemented by placing the browser ASIC realisation on the motherboard such that the browser hardware implementation directly accesses the CPU system bus 504 rather than the CPU internal bus 303 of the highly embedded variant that is shown in FIG. 3.

With reference to FIG. 6, when a browser process is started in accordance with existing computer system designs, step 601, a set of instructions for the process is executed and managed by the CPU along with other processes running concurrently as would be appreciated by the person skilled in the art. The CPU operating system provides CPU cycles to each process.

The browser process is initiated in a similar way however instead of executing solely in the core of the general purpose CPU, the code of the browser is modified to offload either part (Mode A) or all of the browser processing (Mode B) to the hard coded logic on the motherboard, 602, 603 & 604. This logic may be changed and upgraded via processes similar to current practice in the art to upgrade system BIOS, as would be appreciated by the person skilled in the art.

A browser code module is called and is executed in the previously defined hardware logic, at step 604, and continues to be so processed until output is required to the main processor, at step 606. Where such output is required the hardware coded logic provides that output to the mediation layer, at step 607, which presents it via the existing interfaces to the operating system. In effect the mediation layer looks like a standard browser to the operating system allowing the operating system to be unchanged, at the same time the mediation layer passes off processing to hardware logic better suited to its execution.

Security is improved since the browser code cannot be modified by any process running within the general purpose CPU. Speed is improved since the processing time of the browser code in hardware is much faster than the additional processing time to handle calls into and out of the hardware section of the browser logic. In all other respects the processing load, latency and system management should appear no different from the browser code running on the general purpose CPU or host system. Energy conservation is achieved by utilising operating system capability to power down inactive peripherals using existing techniques. In essence since the browser is the dominant process running for many users, energy reduction may be achieved by powering down hard disks, USB, audio, video drivers and the like dependent on the actual usage by the user. The preferred embodiments of the present invention provide for evaluation of such device usage on the fly and allows for power down and subsequent saving in energy usage. Chip level implementation provides a good, economical improvement in browser performance without the requirement to re-engineer the main general purpose CPU chip. The browser hardware implementation can be implemented in standalone ASIC or similar and integrated onto the motherboard in a low risk manner.
3. Card level integration. Here the browser hardware realisation is implemented as a separate PC card allowing retro fit to existing PCs. In this variant energy and browsing speed improvements are brought to PCs or equivalent computing systems that would otherwise not have the browsing performance or capability expected today.

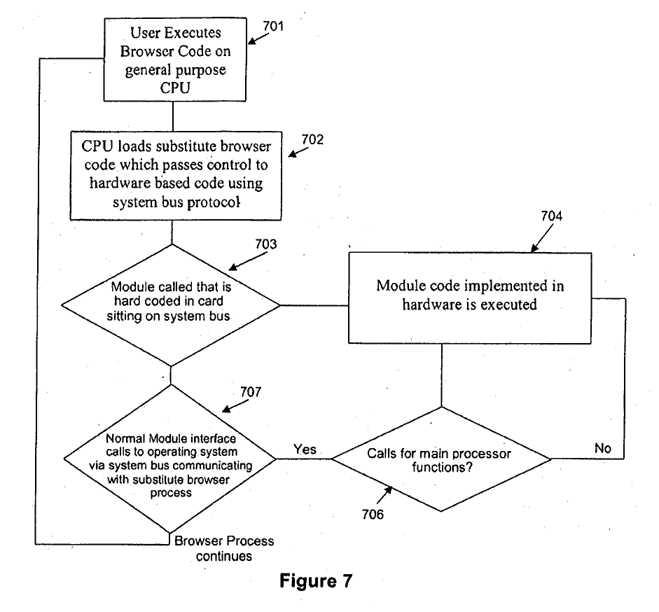

With particular reference to FIG. 7, a standalone card containing the hardware coded browser is implemented such that the browser hardware implementation, again, directly accesses the system bus rather than the CPU internal bus of the highly embedded variant.

With further reference to FIG. 7, when a browser process is started in accordance with existing designs, step 701, a set of instructions for the process is executed and managed by the CPU along with other processes running concurrently as would be understood by the person skilled in the art. The CPU operating system provides CPU cycles to each process. The browser process in this card level implementation is initiated in a similar manner at step 702 however instead of executing solely in the core of the general purpose CPU, the code of the browser is modified to offload either part (Mode A) or all of the browser processing (Mode B) to the hard coded logic on the standalone card, step 703. This logic may be changed and upgraded via processes similar to current practice in the art to upgrade system BIOS, as would be appreciated by the person skilled in the art.

A browser code module is called and is executed in the previously defined hardware logic, at step 704, and continues to be so processed until output is required to the main processor, at step 706. Where such output is required the hardware coded logic provides that output to the mediation layer, at step 707, which presents it via the existing interfaces to the operating system. In effect the mediation layer looks like a standard browser to the operating system allowing the operating system to be unchanged, at the same time the mediation layer passes off processing to hardware logic better suited to its execution.

In the card level implementation, security is improved since the browser code cannot be modified by any process running within the general purpose CPU. Speed is improved since the processing time of the browser code in hardware is much faster than the additional processing time to handle calls into and out of the hardware section of the browser logic. In all other respects the processing load, latency and system management should appear no different from the browser code running on the general purpose CPU. Improved energy consumption is achieved by utilising operating system capability to power down inactive peripherals using existing techniques. In essence since the browser is the dominant process running for many users, energy reduction may be achieved by powering down hard disks, USB, audio, video drivers and the like dependent on the actual usage by the user. In a preferred embodiment, the present invention optionally provides for evaluation of such device usage on the fly and allows for power down and subsequent saving in energy usage.

Card level implementation provides a good, economical improvement in browser performance without the requirement to re-engineer the main general purpose CPU chip or the system motherboard. The browser hardware implementation can be implemented within existing or new systems in a low risk manner.
4. Peripheral integration. Here the browser hardware realisation is implemented as a separate external device such as a USB dongle leveraging the increased speed of local ports, yet still providing security, energy and improved speed of browsing, as well as portability of the browsing experience and user defined configurations. The description of the circuit and function for the external device version is as follows:

A specific hardware coded browser is implemented by placing the browser ASIC realisation on an external device with a suitable interface such as USB. The external device browser hardware implementation directly accesses the CPU system communication port rather than the CPU internal bus of the highly embedded variant, or the system bus of the chip or card level integrations.

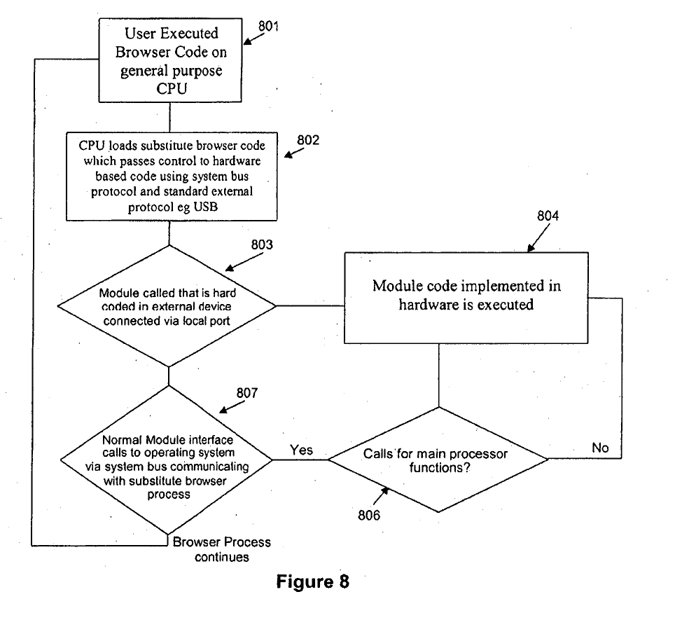

With reference to FIG. 8, when a browser process is started in accordance with existing computer system designs, step 801, a set of instructions for the process is executed and managed by the CPU along with other processes running concurrently as would be understood by the person skilled in the art. The CPU operating system provides CPU cycles to each process. In the present peripheral implementation of a preferred embodiment of the invention the browser process is initiated in a similar way at step 802 however instead of executing solely in the core of the general purpose CPU, the code of the browser is modified to offload either part (Mode A) or all of the browser processing (Mode B) to the hard coded logic on the external device, step 803. This logic may be changed and upgraded via processes similar to current practice in the art to upgrade system BIOS, as would be appreciated by the person skilled in the art.

A browser code module is called and is executed in the previously defined hardware logic, at step 804, and continues to be so processed until output is required to the main processor, at step 806. Where such output is required the hardware coded logic provides that output to the mediation layer, at step 807, which presents it via the existing interfaces to the operating system. In effect the mediation layer looks like a standard browser to the operating system allowing the operating system to be unchanged, at the same time the mediation layer passes off processing to hardware logic better suited to, its execution.

In the peripheral implementation, security is improved since the browser code cannot be modified by any process running Within the general purpose CPU. Speed is improved since the processing time of the browser code in hardware is much faster than the additional processing time to handle calls into and out of the hardware section of the browser logic. In all other respects the processing load, latency and system management should appear no different from the browser code running on the general purpose CPU. This variant also relies on the rapidly increasing port speeds of many systems, for example USB2.0, Firewire and the like. Energy consumption in this implementation is achieved by utilising operating system capability to power down inactive peripherals using existing techniques. In essence since the browser is the dominant process running for many users, energy reduction may be achieved by powering down hard disks, other unused USB devices, audio, video drivers and the like dependent on the actual usage by the user. The peripheral implementation of this preferred embodiment of the present invention provides for evaluation of such device usage on the fly and allows for power down and subsequent saving in energy usage.

Chip level implementation provides a good, economical improvement in browser performance without the requirement to re-engineer the main general purpose CPU chip. The browser hardware implementation can be implemented in standalone ASIC or similar and integrated onto the motherboard in a low risk manner.

A browser in accordance with preferred embodiments of this invention may be implemented in a number of contexts within a data processing system, only one example of which may be a personal computer (PC) architecture, in which, a preferred embodiment comprises a hardware based implementation of internet browser software implemented within a CPU, alongside the CPU, as a separate card within a PC system or as a peripheral. Other applicable computer environments for embodiments of the present invention may comprise:
A client-server;
A mainframe system;
A mobile data processing system;
A mobile telecommunications device;
A telecommunications node;
Computer data network devices including routers, bridges etc where the functions of the preferred embodiments may be distributed or included as integral units;
Field Programmable Units, eg FPGA's
A dedicated web interface terminal
A telemetry or SCADA terminal
A set-top box for television or audio applications.

While this invention has been described in connection with specific embodiments thereof, it will be understood that it is capable of further modification(s). This application including the disclosure of this specification is intended to cover any variations uses or adaptations of the invention following in general, the principles of the Invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

I claim:

1. A data processing system comprising:
central processing means adapted to operate in accordance with a predetermined instruction set, and;
an Internet browser function;
said central processing means, in conjunction with said Internet browser function, being adapted to perform web browsing wherein the Internet browser function is operatively divested from the central processing means.

2. A system as claimed in claim 1, comprising:
computer logic hardware dedicated to operating in accordance with browser application software code for implementing the Internet browser function wherein the computer logic hardware resides within an integrated circuit chip housing the central processor means.

3. A system as claimed in claim 1, comprising:
computer logic hardware dedicated to operating in accordance with browser application software code for implementing the Internet browser function wherein the computer logic hardware resides within a first integrated circuit chip physically separated from a second integrated circuit chip housing the central processor means.

4. A system as claimed in claim 3, wherein the first and second integrated circuit chips are physically located on one and the same CPU printed circuit board.

5. A system as claimed in claim 3, wherein the first and second integrated circuit chips are physically located on separate IC printed circuit boards.

6. A system as claimed in claim 1, comprising:
computer logic hardware dedicated to operating in accordance with browser application software code for implementing the Internet browser function wherein the computer logic hardware resides, at least in part, on a printed circuit board separate to a printed circuit board housing the central processor means.

7. A system as claimed in claim 1, comprising:
computer logic hardware dedicated to operating in accordance with browser application software code for implementing the Internet browser function wherein the computer logic hardware resides, at least in part, within a peripheral device of the data processing system.

8. A system as claimed in claim 2, wherein the computer logic hardware comprises an ASIC.

9. A system as claimed in claim 1, further comprising:
a software mediation layer adapted to communicate messages between an application layer of the data processing system and the operatively divested browser function.

10. A system as claimed in claim 9, wherein the software mediation layer is adapted for by-passing a pre-existing browser application resident in the application layer of the data processing system.

11. A system as claimed in claim 10, wherein the software mediation layer resides within an application layer of the data processing system.

12. A system as claimed in claim 10, wherein the messages communicated between the application layer and the operatively divested browser function comprise one or a combination of browser tasks and instructions.

13. A method of operating a data processing system, the method comprising the steps of:
operatively divesting the browsing of web sites from the central processing of applications.

14. A method of operating a data processing system having a central processor means, the method comprising the steps of:
mediating the processing of browser functions between an operating system and hardware logic operatively separated from the operating system.

15. A method as claimed in claim 14, wherein the hardware logic resides:
in an integrated circuit chip housing the central processor means;
in a first integrated circuit chip physically separated from a second integrated circuit chip housing the central processor means;
at least in part, on a printed circuit board separate to a printed circuit board housing the central processor means; or
at least in part, within a peripheral device of the data processing system.

16. A computer program product comprising:
a computer usable medium having computer readable program code and computer readable system code embodied on said medium for operatively isolating the browsing of web sites from the central processing of applications within a data processing system, said computer program product comprising:
computer readable code within said computer usable medium for performing the method steps of claim 14.

17. (canceled)

18. (canceled)

19. A system as claimed in claim 3, wherein the computer logic hardware comprises an ASIC.
